(19) United States
(12) Patent Application Publication
(10) Pub. No.: US 2014/0279120 A1
(43) Pub. Date: Sep. 18, 2014

(54) Purchase Triggering

(71) Applicant: Egan Echeverría Schulz, San Jose, CA (US)

(72) Inventor: Egan Echeverría Schulz, San Jose, CA (US)

(21) Appl. No.: 13/796,982

(22) Filed: Mar. 12, 2013

(51) Int. Cl. G06Q 40/00

(52) U.S. Cl. CPC G06Q 40/00
USPC 705/26.1

(57) ABSTRACT

Methods and systems are provided for determining what follow on products should be purchased after the purchase of an initial product, when the follow on products should be purchased, and approximately how much the follow on products will likely cost. Money can be budgeted to purchase the follow on products. Money can automatically be saved for such purchases. Thus, the user can be spared the trouble and inconvenience of having to plan for and save money for the purchase of follow on products. The user can also be spared the problems associated with not having the follow on products when they are needed.

### BACKGROUND

1. Technical Field

The present disclosure generally relates to electronic commerce and, more particularly, relates to methods and systems for triggering one or more subsequent purchases after an initial purchase.

2. Related Art

Often the purchase of one product (e.g., an initial product), necessitates the purchase of one or more other products (e.g., follow on products). The follow on products must often be purchased at a substantial expense to the purchaser. For example, when a person purchases a car, it is likely that the person will need new tires in about one and a half years. Tires can be a substantial expense. The person must also make periodic purchases of less costly items such as for gasoline, routine maintenance, and insurance.

As a further example, a person can purchase a video game system, e.g., a video game console such as an Xbox, Nintendo, or PlayStation. The user can expect to purchase additional video games, as well as system upgrades and accessories (such as addition or different controllers) over the next year.

As yet a further example, a person purchase a battery powered radio controlled (RC) car as a gift for a child. The person can expect to need additional batteries in the near future, as well as various parts over the next year.

Indeed, it is not unusual for the total cost of such follow on products to exceed the cost of the initial product. The operational and maintenance costs of a car can, in the long run, exceed the purchase price of the car. The cost of video games and accessories can, even in the short run, exceed the cost of a game console. The cost of batteries and parts can exceed the cost of a radio controlled car. Thus, the costs of such follow on products can be substantial.

### BRIEF DESCRIPTION OF THE DRAWINGS

FIG. 1 is a block diagram of a system for providing purchase triggering, according to an embodiment;

FIG. 2 is a flow chart showing a method for providing purchase triggering, according to an embodiment;

FIG. 3 is a flow chart showing further detail of the method for providing purchase triggering, according to an embodiment; and

FIG. 4 is a block diagram of an example of a computer that is suitable for use in the system for providing purchase triggering, according to an embodiment.

### DETAILED DESCRIPTION

As discussed above, the purchase of an initial product often necessitates the purchase of one or more follow on products, often at a substantial expense to the purchaser. Thus, after some such products are purchased, money must be budgeted and saved for the likely follow on products.

According to one or more embodiments, methods and systems are provided for determining what follow on products should be purchase after purchasing the initial product, determining when the follow on products should be purchased (or are likely to be needed), and determining approximately how much the follow on products will likely cost.

According to one or more embodiments, methods and systems are provided for budgeting money to purchase the follow on products and for automatically saving the money required for such purchases. Thus, the user can be spared the trouble and inconvenience of having to plan for and save money for the purchase of the follow on products. The user can also be spared the problems associated with not having the follow on products when they are needed. Such automatic saving can be with or without real-time authorization from the user. Preauthorization for such automatic saving can be provided by user, such as during a setup process.

Saving money for purchasing the follow on products can comprise setting the money aside for such purchases. That is, saving the money can simply comprise allocating the money for the follow on products and not using the money for another purpose. Saving money for purchasing the follow on products can comprise transferring the money to an account, such as an account dedicated to facilitating the purchase of follow on products.

For example, a customer can purchase a new car, such as a BMW Z4 (i.e., the initial purchase). This initial purchase can require that the customer has enough money in one and a half years to purchase a new set of four new tires (i.e., the follow on purchase). The tires can cost $400 each. Therefore, in one and a half years $1,600 dollars should be set aside, such as in a smart folder inside the user's payment provider account. Over the one and a half years, the necessary amount of money, e.g., $1,600, can accrue according to a predetermined schedule. The necessary money can accrue from or within the user's checking or savings account, for example.

This purchase also requires setting aside money every 6 months for insurance. The purchase triggering system can look at past purchases of car insurance and can forecast how much money the user needs to set aside every week to be ready to pay for the car insurance.

Smart folders can be used for such saving. For example, smart folders of a payment provider such as PayPal can be used for such saving. In an interface, such as within an app, the user can view the smart folders, see what the money in each smart folder is designated for and how much money is currently in each smart folder, as well as when each smart folder will reach maturity (i.e., have sufficient money for the purchase of the designated follow on product).

As another example, a customer can purchase an Xbox for Christmas. The user can decide that three additional video games and a new joystick should be purchased, once the money is saved. A smart folder (such as for Xbox related purchases) with sub smart folders (one for each game and one for the joystick) can be created. The user can start putting a selected amount of money in the folder every day, week, or month to facilitate the purchase these games. The amounts to be saved can be based, at least in part, on their release dates of the games, such that the money is available when the games are released.

As yet another example, a customer can purchase a battery powered car for her son for a birthday. It comes with batteries. However since batteries only last for so long, a smart folder can be created to accommodate the purchase of additional batteries over the course of the next 2 months. One month into use of the smart folder, an offer at Target for those batteries becomes available. Instead of waiting for the smart folder to mature, the mobile application can notify the user, such as via beeps of buzzes, thus letting the user know the offer is available at Target and that the batteries must be within the next 2 days to take advantage of the offer.

Thus, the purchase trigger system can take advantage of changing circumstances, e.g., special offers, that can benefit the user. Lacking such an offer, the system can notify the user when the folder is mature, such when enough money has been saved to purchase the batteries according to the desired schedule.

According to an embodiment, a system can comprise one or more memories and one or more hardware processors in communication with the one or more memories. The one or more hardware processors can receive a communication including an indication of a purchase of an initial product by a user on a purchase date; determine, at least in part from the initial product, what follow on products correspond to the initial product; determine, at least in part from the follow on products, what a cost is for each of the follow on products; determine, at least in part from the initial product and the purchase date, a schedule for purchasing the follow on products; determine, at least in part from the follow on products, the cost for each of the follow on products, and the schedule, a budget for purchasing the follow on parts; and store, in the one or more memories, information representative of the budget and the schedule.

The budget and/or the schedule can be communicated to the user. The user can authorize the budget and/or the schedule. The user can modify the budget and/or schedule. The user can authorize the budget and/or the schedule on an item by items basis. Thus, the user can authorized some items and can decline or modify other items of the budget and/or schedule. This can be done when the user is first presented with the budget and/or schedule, such as soon after the initial purchase. This can be done at any other time.

According to an embodiment, the user can modify the budget and/or schedule, as desired. The user can modify the budget and/or schedule in any desired manner. The user can modify the budget and/or schedule at any desired time. For example, the budget and/or schedule can be modified at any time to reflect an early purchase of a follow on product by the user. As a further example, the budget and/or schedule can be modified at any time to reflect the user's desire not to purchase a specified follow on product.

The budget and/or the schedule can be communicated to a person or device designated by the user. For example, budget and/or the schedule can be communicated to the user's spouse, accountant, money manager, friend, website, home computer, and/or user device. The budget and/or the schedule can be communicated to any desired entity.

A warning can be provided to the user if saved money decreases below or fails to reach a predetermined level. For example, save money can decrease below the predetermined level (such as the level at which scheduled savings such cause the level to be) due to account fees, withdrawals, and the like. In such instances, the warning can be sent to a person or device designated by the user. For example, warning can be communicated to the user's spouse, accountant, money manager, website, home computer, and/or user device.

The one or more memories and/or one or more hardware processors can be part of the same device, e.g., server. The one or more memories and/or one or more hardware processors can be part of the different devices, e.g., servers. The one or more memories and/or one or more hardware processors can be co-located. The one or more memories and/or one or more hardware processors can be located in different places, e.g., different rooms, different buildings, different cities, or different states.

Determining what follow on products correspond to the initial product can comprise looking up the initial product in a database to determine what follow on products have been associated therewith. The database can be a database of the payment provider, the merchant, the social network, or any other database.

Determining what follow on products correspond to the initial product can comprise querying. For example, determining what follow on products correspond to the initial product can comprise querying a merchant who sells the initial product and/or at least one of the follow on products.

Determining what follow on products correspond to the initial product can comprise an Internet search for the initial product. The follow on products can be inferred from the results of the Internet search. For example, if the user shows that it is common for purchasers of surfboards to purchase wetsuits, then wetsuits can be inferred to be follow on products for surfboards.

Determining the cost for each of the follow on products can comprise looking up the initial product on merchant websites or in catalogs. A database of costs can be created and maintained from such information as it is obtained.

Determining the schedule for purchasing the follow on products can be performed using information from merchants, information from user manuals, sells information (such as from credit card companies, payment provides, banks, and the like). Determining the schedule for purchasing the follow on products can be performed using information from maintenance manuals or user manuals. For example, the user manual for an automobile will frequently include a maintenance schedule. The maintenance schedule will show when various maintenance procedures are to be performed, and thus when the associated expenditures are to be expected. This information can be used, at least in part, to define the schedule.

The schedule can also be defined or determined, at least in part, based on user habits or purchases. For example, if the user has a history of driving a car many more miles than average or has a history of replacing tires sooner (such as due to more wear put on the tires, the use of higher performance tires that wear out more quickly, a practice of generally underinflating tires such that they will need replacing sooner, etc.), the schedule may be shorter, e.g., may require purchases sooner.

Schedules can also be longer, such as if the user rarely uses an electronic product so that batteries do not need to be replaced on the same schedule as an average used electronic product. Such information can be determined by looking at user past purchases that are related to the item or a like item. A database of such user product use can be created and maintained to determine, at least in part, such schedules. Schedules may also be dynamic, such as by being based on user purchases. For example, an initial schedule may be set for replacing tires, but if the user does not replace the tires until much later or replaces the tires much sooner, the next scheduled tire replacement can be adjusted accordingly.

The schedule can be based upon location. For example, tire wear in some locations may be more rapid (such as due to more stop and go traffic) than in other locations. As a further example, cold or snowy weather can require more frequent service or maintenance purchases for some products, such as cars.

Thus, the schedule can be based on user habits, user past purchases, product usage or any other personal or product related criteria. The schedule can based on any criteria that provide some indication of when maintenance should be done or when follow up purchases should be made.

A database can be created to associate follow on products with initial products, to provide prices for follow on products, and to provide information regarding when follow on products are to be purchased one an initial product has been purchase. The database can be used to determine the follow on products, their prices, and when they should be purchased, as discussed herein. The database can be created, maintained, updated, and used by a payment server, bank, a credit card company or any other entity.

The user can be queried to determine what follow on products should be purchase, how much the follow on products costs, and/or when the follow on product should be purchased. Such information from users can be used to create and update the database

The one or more memories and the one or more hardware processors can be part of a server, such as a server of a payment provider, a server of a merchant, a server of a social network, and/or a server of any other entity. The one or more memories and the one or more hardware processors can be part of a user device, such as a smart phone. The one or more memories and the one or more hardware processors can be part of a combination of such devices.

The communication can be received from a merchant device, the user device, or any other device. For example, the communication can be from a server of a social network. Thus, the purchase of the initial product can be communicated to the one or more hardware processors via a social network. The purchase of the initial product can be communicated to the one or more hardware processors via a bank, a credit card company, a payment processor, a payment provider, a merchant, or any other entity.

The one or more memories can store information indicative of what follow on products correspond to what initial products. The one or more hardware processors can be operable to determine what follow on products correspond to the initial product can comprise accessing the information indicative of what follow on products correspond to what initial products stored in the one or more memories.

The one or more memories store information indicative of what a cost is for each of the follow on products. The one or more hardware processors can determine what the cost is for each of the follow on products comprises accessing the information indicative of what the cost is for each of the follow on products stored in the one or more memories.

The one or more memories can store information indicative of when the follow on products are needed after the initial product is purchased. The one or more hardware processors can determine the schedule comprises accessing the information indicative of when the follow on products are needed after the initial product is purchased stored in the one or more memories.

The one or more hardware processors can be operable to save money of the user to facilitate purchasing of one or more follow on products according to the budget. The one or more hardware processors can transfer money from one account of the user to another account of the user to facilitate purchasing of one or more follow on products according to the budget.

The one or more hardware processors can send a communication to the user including the budget and schedule and receive a communication from the user indicating an authorization to save money according to the budget and to purchase the follow on product according to the schedule. The communication from the user can modify the budget and/or the schedule.

The one or more hardware processors can automatically purchase the follow on products according to the schedule. Such automatic purchase can be with or without real-time authorization from the user. Preauthorization for such automatic purchase can be provided by user, such as during the setup process.

According to an embodiment, a method can comprise storing, in one or more memories, information regarding purchases. The method can comprise receiving, via one or more hardware processors, a communication including an indication of a purchase of an initial product by a user on a purchase date. The method can comprise determining, via the one or more hardware processors, at least in part from the initial product, what follow on products correspond to the initial product. The method can comprise determining, via the one or more hardware processors, at least in part from the follow on products, what a cost is for each of the follow on products. The method can comprise determining, via the one or more hardware processors, at least in part from the initial product and the purchase date, a schedule for purchasing the follow on products. The method can comprise determining, via the one or more hardware processors, at least in part from the follow on products, the cost for each of the follow on products, and the schedule, a budget for purchasing the follow on parts. The method can comprise storing, via the one or more hardware processors and in the one or more memories, information representative of the budget and the schedule.

According to an embodiment, a computer program product can comprise a non-transitory computer readable medium. The non-transitory computer readable medium can have computer readable and executable code for instructing one or more processors to perform any of the methods disclosed herein.

For example, the non-transitory computer readable medium can have computer readable and executable code for instructing one or more processors to perform a method for providing purchase triggering. The method can comprise storing information regarding purchases. receiving a communication including an indication of a purchase of an initial product by a user on a purchase date; determining, at least in part from the initial product, what follow on products correspond to the initial product; determining at least in part from the follow on products, what a cost is for each of the follow on products; determining, at least in part from the initial product and the purchase date, a schedule for purchasing the follow on products; determining, at least in part from the follow on products, the cost for each of the follow on products, and the schedule, a budget for purchasing the follow on parts; and storing information representative of the budget and the schedule.

Determining what follow on products correspond to the initial product can comprise accessing the information indicative of what follow on products correspond to what initial products stored in the one or more memories. Determining what the cost is for each of the follow on products can comprise accessing the information indicative of what the cost is for each of the follow on products stored in the one or more memories. Determining the schedule comprises accessing the information indicative of when the follow on products are needed after the initial product is purchased stored in the one or more memories.

FIG. 1 is a block diagram of a system for purchase triggering, according to an embodiment. The system can include a merchant device 110, a mobile device 120, and/or a payment server 130. The functions discussed herein can be split and/or shared amount the merchant device 110, the mobile device 120, and/or the payment server 130, as desired.

The merchant device 110 can comprise a merchant checkout terminal, a computer, and/or a server, for example. The merchant device 110 can include a memory 111 and a processor 112. The merchant device 110 can be used for making routine purchases from the merchant. The merchant device 110 can be used for purchaser triggering.

The mobile device 120 can be carried by the user. The mobile device 120 can comprise a cellular telephone, a smart telephone, a hand held computer, a laptop computer, a notebook computer, or a tablet computer, for example. The mobile device 120 can include a processor 121, a memory 122, and a global positioning system (GPS) 123. The mobile device 120 can be used for routine telephone calls, text messaging, and web browsing. The mobile device 120 can be used for purchase triggering.

An app 124 can be stored in the memory 122 and executed by the processor 121. The app 124 can be used for purchase triggering, as discussed herein. The app 124 can facilitate setup and use of the purchase triggering system. For example, the app 124 can facilitate receiving of the budget and schedule, modifying or the budget and schedule, authorization or approval of the budget and schedule, and receiving of notices (such as notices that confirm money transfers among accounts or confirm purchases of follow on products). The app 124 can operate or cooperate to save money according to the budget and/or schedule and to purchase, reserve, or order the follow on products.

The server 130 can comprise a server of a payment provider, such as Paypal, Inc. The server 130 can comprise a server of a credit card company, a bank, a payment processor, a social network, a merchant, a dedicated purchase triggering company, or any other entity. The server 130 can be a single server or can be a plurality of servers. The server 130 can include one or more processors 131 and a memory 132. The memory 132 can be a memory of the server 130 or a memory that is associated with the server 130. The memory 132 can be a distributed memory. The memory 132 can store a user account 133 and a merchant account 134.

The server 130 can be used for credit card processing, payment processing, banking, social networking, purchasing, or any other purpose or combination of purposes. The server 130 can be used for purchasing triggering. The server 130 can comprise a relevancy engine. The relevancy engine can determine, at least in part from the initial purchase, what follow on products should be purchased, when the follow on products should be purchased, and/or how much money should be saved for the follow on products. The relevancy engine can determine what products are likely follow on product for a particular initial product. The relevancy engine can determine what products are likely to be relevant to a particular initial product. For example, the relevancy engine can look up an initial product in a database and determine, from the database, what other products are commonly associated therewith. The database can be created and maintained for use by the relevancy engine. As a further example, the relevancy engine can search other sources, such as merchant catalogs, merchant brochures, repair and maintenance manuals, the Internet, other network, and the like, for information that relates an initial product to one or more follow on products.

The relevancy engine can use artificial intelligence to determine what follow on product are to be associated with what initial products. For example, the relevancy engine can use heuristics to determine what follow on product are to be associated with what initial products. The relevancy engine can store prior examples of such associations for use in making future associations. The relevancy engine can use exact prior examples to determine such associations.

The relevancy engine can use estimations or approximate prior examples to determine such associations. For example, if prior associations of follow on products are available for a 2011 Chevrolet Corvette, but are not available for a 2012 Chevrolet Corvette, then the relevancy engine can take advantage of the parts associated with the 2011 Chevrolet Corvette, such by making the appropriate substitutions (such as by replacing parts appropriate for the 2011 Chevrolet Corvette with parts appropriate for the 2012 Chevrolet Corvette).

The relevancy engine can check for upgrades, new products, improved products, discounted products, better deals on products, and the like. Such upgrades, new products, improved products, discounted products, better deals on products, and the like can be suggested to the user as substitutions for the products recommended according to the budget and schedule.

The relevancy engine can use product descriptions, manuals, the Internet, product reviews, and the like to determine when the follow on products should be purchased, and/or how much money should be saved for the follow on products. The relevancy engine can use any source or sources of information to make such determinations.

Generally, the merchant device 110, the mobile device 120, and the payment server 130 can perform functions discussed herein. That is, at least to some extent, a function that is discussed herein as being performed via one of these devices can be performed by a different one of these devices or by a combination of these devices.

The merchant device 110, the mobile device 120, and the server 130 can communicate with one another via a network, such as the Internet 140. The merchant device 110, the mobile device 120, and the server 130 can communicate with one another via one or more networks, such as local area networks (LANs), wide area networks (WANs), cellular telephone networks, and the like. The merchant device 110, the mobile device 120, the social network 150, and the server 130 can communicate with one another, at least partially, via one or more near field communications (NFC) methods or other short range communications methods, such as infrared (IR), Bluetooth, WiFi, and WiMax.

FIG. 1 illustrates an exemplary embodiment of a network-based system for implementing one or more processes described herein. As shown, the network-based system may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or another suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

FIGS. 2 and 3 are flow charts that describe examples of operation of the system for purchase triggering according to embodiments thereof. Note that one or more of the steps described herein may be combined, omitted, or performed in a different order, as desired or appropriate.

FIG. 2 is a flow chart showing a method for providing purchase triggering, according to an embodiment. A user can purchase an initial product, as shown in step 201. The initial product can be any product for which the use or ownership thereof can benefit from the purchase of one or more other products, e.g., follow on products. For example, the initial product can be a video game console, a car, or a house.

Information indicative of the purchase can communicated to the server 130, as shown in step 202. The information can be communicated to the server 130 via the cellular network, the Internet 140, or any other means.

A budget for saving money to facilitate the purchase of one or more follow on products and a schedule for purchasing the follow on products can prepared, at least in part, by the server 130, as shown in step 203. The budget and the schedule can be prepared, at least in part, by the merchant device 110, the user device 120, the user, and/or any other device or entity.

The budget can be determined, at least in part, by the price for each follow on product and the date on which the purchase of each follow on products is to be made. Taxes, inflation, likely changes in prices, and the like can be taken into consideration when determining the price of each follow on product. The budget can define the amounts of money to be saved by the user so that the purchase of follow on products can be made on time. Saving the money can include setting the money aside, such as designation a portion of money within an account for the purchase of follow on products. Saving money can include transferring the money from one account to another. For example, saving money can include transferring the money from a checking account to a payment provider account. The account to which the money is transferred can be specifically for facilitating the purchase of the follow on products.

The schedule can indicate when the purchases are to be made so that the follow on products are available when needed or desired. The schedule can show calendar dates on which the follow on products can be purchase so as to be available when needed or desired.

The purchase triggering system can cooperate with one or more merchant inventory to assure that the follow on products are available when needed. Thus, the purchase triggering system can cause the merchant inventory system to order and/or reserve follow on products for the user.

A budget and the schedule are communicated from the server 130 to the user device 120, as shown in step 204. The budget and schedule can include a list of follow on products, the costs of the follow on products, and the dates upon which the follow on products are to be purchased.

The budget and schedule can include a list of alternative follow on products. Each alternative follow on product can be used in place of one or more of the other follow on products. The user can determine when and if such alternative products are to be listed. For example, the user can specify, such as during a setup process or real-time, that only alternative products that provide at least a 25% cost savings are to be listed.

The budget and schedule can include a list of optional follow on products. The optional follow on products are products that are not likely to be required, but that the user may want to consider. Listing the optional follow on products provides the user with an opportunity to consider the optional follow on products. The user can determine when and if such optional products are to be listed. For example, the user can specify, such as during a setup process or real-time, that only optional products manufactured by a particular company are to be listed.

The budget and schedule can list the follow on products according to the likelihood that they will be needed and/or should be purchased. For example, the budget and schedule can list the follow on products as absolutely needed, possibly needed, and may be needed. Such listing can help the user determine which items are to be kept on the budget and schedule and which items may be modified or eliminated from the budget and schedule.

The likelihood of needing each part can be provided. For example, the likelihood can be listed as a percentage. In this instance, for example, 100% can indicate that the product is certain to be needed (like new tires, for example) and 50% can indicate that it is unknown whether the part is more likely to be needed or more likely not to be needed.

The budget and schedule can include a contingency fund. This may be particularly appropriate for larger purchases, such as cars and houses. For such larger purchases, unexpected and unpredictable expenses are more likely to arise. The user can predetermine when such a contingency fund is to be include, such as by specifying that it is to be include for all purchase over a predetermined money amount. The purchase triggering system can predetermine when such a contingency fund is to be included, such as by specifying that it is to be include for all purchase over a predetermined money amount. The user can add to, subtract from, or delete the contingency fund during the set up process, when the budget and schedule are presented to the user, and/or at any other time.

The user can review the proposed purchase of follow on products and decide which, if any, of the follow on products are to be included in the budget and the schedule. The user can decide which, if any, of the alternative follow on products are to be purchased. The user can decide which, if any, of the optional follow on products are to be purchased. The default for the alternative and/or optional follow on products can be that they are not to be purchased unless the user indicates that they are to be purchased. Indicating that an alternative follow on product is to be purchased can automatically indicate that the originally suggested follow on product is not to be purchased.

The user can authorize the budget and the schedule and can communicate the authorization from to the user device to the server 130, as shown in step 205. The user can modify the budget and/or the schedule prior to communicating the authorization. For example, the user can modify the budget and schedule by eliminating one or more follow on products, adding one or more new follow on products, changing one or more of the originally suggested follow on products to corresponding alternative follow on products, selecting one or more of the optional products to be included in the budget and schedule.

The projected cost and/or availability of products can be used, at least in part, to determine what, if any, alternative follow on products are to be suggested to the user. For example, if a shortage of one brand has occurred regularly in the past, the user can be notified of this fact and a different, alternative, brand or follow on product can be suggested.

The server 130 can facilitate saving of the money for the purchase of the follow on products, as shown in step 206. The server 130 can facilitate saving of the money for the purchase of the follow on products by setting aside or sequestering. The server 130 can facilitate saving of the money for the purchase of the follow on products by transferring money among accounts.

The server 130 can facilitate the purchase of the follow on products on the scheduled dates, as shown in step 207. The server 130 can notify the user that the purchases need to be made. The server 130 can make the purchases, such as from online merchants. The server 130 can have the following on products delivered to the user, such as to a place designated by the user in real-time or during a setup process.

FIG. 3 is a flow chart showing further detail of the method for providing purchase triggering, according to an embodiment. One or more hardware processors receive a communication including an indication of a purchase of an initial product by a user on a purchase date, as shown in step 301. The one or more hardware processors determine what follow on products correspond to the initial product, as shown in step 302. The one or more hardware processors determine what a cost is for each of the follow on products, as shown in step 303. The one or more hardware processors determine a schedule for purchasing the follow on products, as shown in step 304. The one or more hardware processors determine the budget for purchasing the follow on parts, as shown in step 305. Information representative of the budget and the schedule is stored in one or more memories, as shown in step 306.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

Payment processing can be through known methods, such as transaction details being communicated to the payment provider through the app, the payment provider processing the details, which may include user account and identifier information and authentication, merchant information, and transaction details. The user account may be accessed to determine if any restrictions or limitations may prevent the transaction from being approved. If approved, the payment provider may send a notification to the merchant and/or the user.

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

When a follow on product is identified, the identification of the follow on product can trigger the identification of further follow on products. Thus, a follow on product can become an initial purchase with its own follow on product. This process can repeat indefinitely. This process can be limited, such as by the user or by the purchase triggering system.

Saving can be done using substantially equal periodic payments. Saving can be done using substantially unequal periodic payments. Saving can be done using substantially equal non-periodic payments. Saving can be done using substantially unequal non-periodic payments. The user can define the payment schedule for saving.

As used herein, the term “store” can include any business or place of business. The store can be a brick and mortar store or an online store. The store can be any person or entity that sells a product.

As used herein, the term “product” can include any item or service. Thus, the term “product” can refer to physical products, digital goods, services, or anything for which a user can make a payment, including charitable donations. A product can be anything that can be sold. Examples of products include cellular telephones, concerts, meals, hotel rooms, automotive repair, haircuts, digital music, and books. The product can be a single item or a plurality of items. For example, the product can be a tube of toothpaste, a box of laundry detergent, three shirts, and a donut.

As used herein, the term “merchant” can include any seller of products. The term merchant can include a store. The products can be sold from a store or in any other manner.

As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “network” can include one or more local area networks (LANs) such as business networks, one or more wide area networks (WANs) such as the Internet, one or more cellular telephone networks, or any other type or combination of electronic or optical networks.

As used herein, the term “card” can refer to any card or other device that can be used to make a purchase in place of cash. For example, the card can be a bank card, credit card, debit card, gift card, or other device. The card can be a token, such as a hardware token or a software token. The card can be stored in and/or displayed upon a user device, such as a cellular telephone.

As used herein, the term “budget” can refer to information, such as a report, that indicates how much money is required for a particular activity, such as the purchase of one or more follow on products. The budget can take into account when such purchases are to be made, so as to more readily facilitate saving money for such purchases. The budget can take into account such factors as taxes, inflation, deflation, likely price changes (such as based upon a history of the economy, the industry, the product, and/or the merchant). Thus, the budget can indicate how much money is needed and when the money is needed for one or more purchases.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
one or more memories;
one or more hardware processors in communication with the one or more memories and operable to:
receive a communication including an indication of a purchase of an initial product by a user on a purchase date;
determine, at least in part from the initial product, what follow on products correspond to the initial product;
determine, at least in part from the follow on products, what a cost is for each of the follow on products;
determine, at least in part from the initial product and the purchase date, a schedule for purchasing the follow on products;
determine, at least in part from the follow on products, the cost for each of the follow on products, and the schedule, a budget for purchasing the follow on products; and
storing, in the one or more memories, information representative of the budget and the schedule.

2. The system of claim 1, wherein:
the one or more memories store information indicative of what follow on products correspond to what initial products; and
one or more hardware processors are further operable to determine what follow on products correspond to the initial product comprises accessing the information indicative of what follow on products correspond to what initial products stored in the one or more memories.

3. The system of claim 1, wherein:
the one or more memories store information indicative of what a cost is for each of the follow on products; and
one or more hardware processors are further operable to determine what the cost is for each of the follow on products comprises accessing the information indicative of what the cost is for each of the follow on products stored in the one or more memories.

4. The system of claim 1, wherein:
the one or more memories store information indicative of when the follow on products are needed after the initial product is purchased; and
one or more hardware processors are further operable to determine the schedule comprises accessing the information indicative of when the follow on products are needed after the initial product is purchased stored in the one or more memories.

5. The system of claim 1, wherein the one or more hardware processors are further operable to save money of the user to facilitate purchasing of one or more follow on products according to the budget.

6. The system of claim 1, wherein the one or more hardware processors are further operable to transfer money from one account of the user to another account of the user to facilitate purchasing of one or more follow on products according to the budget.

7. The system of claim 2, wherein the one or more hardware processors are further operable to:
send a communication to the user including the budget and schedule; and
receive a communication from the user indicating an authorization to save money according to the budget and to purchase the follow on product according to the schedule.

8. The system of claim 2, wherein the one or more hardware processors are further operable to:
send a communication to the user including the budget and schedule; and
receive a communication from the user modifying at least one of the budget and the schedule

9. The system of claim 2, wherein the one or more hardware processors are further operable to automatically purchase the follow on products according to the schedule.

10. The system of claim 1, wherein the schedule is based upon a habit of the user.

11. The system of claim 1, wherein the schedule is based upon a location of the user.

12. A method comprising:
storing, in one or more memories, information regarding purchases;
receiving, via one or more hardware processors, a communication including an indication of a purchase of an initial product by a user on a purchase date;
determining, via the one or more hardware processors, at least in part from the initial product, what follow on products correspond to the initial product;
determining, via the one or more hardware processors, at least in part from the follow on products, what a cost is for each of the follow on products;
determining, via the one or more hardware processors, at least in part from the initial product and the purchase date, a schedule for purchasing the follow on products;
determining, via the one or more hardware processors, at least in part from the follow on products, the cost for each of the follow on products, and the schedule, a budget for purchasing the follow on parts; and
storing, via the one or more hardware processors and in the one or more memories, information representative of the budget and the schedule.

13. The method of claim 12, wherein:
the one or more memories store information indicative of what follow on products correspond to what initial products; and
further comprising determining what follow on products correspond to the initial product comprises accessing the information indicative of what follow on products correspond to what initial products stored in the one or more memories.

14. The method of claim 12, wherein:
the one or more memories store information indicative of what a cost is for each of the follow on products; and
further comprising determining what the cost is for each of the follow on products comprises accessing the information indicative of what the cost is for each of the follow on products stored in the one or more memories.

15. The method of claim 12, wherein:
the one or more memories store information indicative of when the follow on products are needed after the initial product is purchased; and
further comprising determining the schedule comprises accessing the information indicative of when the follow on products are needed after the initial product is purchased stored in the one or more memories.

16. The method of claim 12, further comprising saving money of the user to facilitate purchasing of one or more follow on products according to the budget.

17. The method of claim 12, further comprising transferring money from one account of the user to another account of the user to facilitate purchasing of one or more follow on products according to the budget.

18. The method of claim 12, further comprising:
sending a communication to the user including the budget and schedule; and
receiving a communication from the user indicating an authorization to save money according to the budget and to purchase the follow on product according to the schedule.

19. The method of claim 12, further comprising:
sending a communication to the user including the budget and schedule; and
receiving a communication from the user modifying at least one of the budget and the schedule

20. The method of claim 12, further comprising automatically purchasing the follow on products according to the schedule.

21. A computer program product comprising a non-transitory computer readable medium having computer readable and executable code for instructing one or more processors to perform a method, the method comprising:
storing information regarding purchases;
receiving a communication including an indication of a purchase of an initial product by a user on a purchase date;
determining, at least in part from the initial product, what follow on products correspond to the initial product;
determining at least in part from the follow on products, what a cost is for each of the follow on products;
determining, at least in part from the initial product and the purchase date, a schedule for purchasing the follow on products;
determining, at least in part from the follow on products, the cost for each of the follow on products, and the schedule, a budget for purchasing the follow on parts; and
storing information representative of the budget and the schedule.

22. The computer program product of claim 21, wherein:
determining what follow on products correspond to the initial product comprises accessing the information indicative of what follow on products correspond to what initial products stored in the one or more memories;
determining what the cost is for each of the follow on products comprises accessing the information indicative of what the cost is for each of the follow on products stored in the one or more memories; and
determining the schedule comprises accessing the information indicative of when the follow on products are needed after the initial product is purchased stored in the one or more memories.
